(19) United States
(12) Patent Application Publication
(10) Pub. No.: US 2025/0165943 A1
(43) Pub. Date: May 22, 2025

(54) A SYSTEM AND A METHOD FOR MULTIPLE PURCHASES IN A VENDING MACHINE

(71) Applicant: NU VENDING SDN BHD, Kajang (MY)

(72) Inventor: Sai Ming LIU, Kajang (MY)

(73) Assignee: NU VENDING SDN BHD, Kajang (MY)

(21) Appl. No.: 18/838,994

(22) PCT Filed: Feb. 16, 2022
(86) PCT No.: PCT/MY2022/050010

§ 371 Date: Aug. 15, 2024

(51) Int. Cl. G06Q 20/18; G06Q 20/40; G06Q 30/0207; G06Q 30/0226; G07F 11/46

(52) U.S. Cl. CPC G06Q 20/18; G06Q 20/407; G06Q 30/0226; G06Q 30/0237; G07F 11/46

(57) ABSTRACT

The present invention relates to a system for multiple purchases in a vending machine, comprising a display configured to receive a user's order of multiple items, and a payment device configured to accept the user's payment, in which the ordered items are dropped by at least one dispensing coil after the user's payment is successfully accepted. Further, an elevator is configured to consecutively receive each dropped item and deliver all the dropped items to an item retrieval port in one attempt, and a drop sensor is configured to determine whether each of the ordered items is dropped to the elevator, in which a certain amount is refunded to the user in the event that at least one of the ordered items is not dropped to the elevator. The present invention also relates to a method (100) for multiple purchases in a vending machine.

### TECHNICAL FIELD

The present invention pertains to the field of vending machine systems. More particularly, the present invention relates to a system and a method for multiple purchases in a vending machine.

### BACKGROUND ART

The use of multiple purchases in a vending machine can yield increased sales and opportunities for new market promotions. Multiple purchases allow for two or more products to be sold together with a single interaction with the vending machine. Increased sales revenues can be achieved by offering both products at a price less than the amount charged if both products were sold separately. Moreover, marketing opportunities become available when customers are attracted to try new products at reduced prices that are linked by brand name to older better known products.

Several attempts have been made to incorporate the idea of multiple purchases into a vending machine, some of the attempts are discussed in the following prior art references.

WO2001086602A2 discloses a selection method and mechanism which causes multiple products from one or more vending machines to be dispensed through use of a single selection. The single selection mechanism can be the use of a single button either dedicated to this function or can be a button designated from the normal buttons on a selection key pad. The single selection can be the pushing of multiple buttons in a single selection process. The selection can be made after the establishment of sufficient credit in the machine to purchase the selection.

CN109345735A relates to a product identification method and a system for an unmanned vending machine. The method comprises the following steps of: taking a pre-purchase product image of all the products currently being sold before a consumer purchases; analyzing the types and the quantities of all the products in the unmanned vending machine before the purchase by image recognition; comparing with a purchased product image after the purchase; and analyzing the missing products after the purchase by the image recognition to obtain the types and the quantities of the products purchased this time. Therefore, the sales of a wide range of the products can be realized. According to the method and the system provided, multiple products can be detected and identified at one time, and the consumer can conveniently purchase multiple products at one time.

The aforementioned references may strive to provide vending machine systems with multiple-purchase function. Nevertheless, they still have a number of limitations and shortcomings. For example, none of the aforementioned references provides a refund mechanism when the vending machine does not dispense the purchased items. Moreover, the aforementioned references do not provide a solution for quick dispensing when a user purchases a large quantity of items in a single transaction.

Accordingly, it can be seen that there exists a need to have an improved vending machine system for multiple purchases which can overcome the aforesaid limitations and shortcomings.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

An objective of the present invention is to provide a vending machine system for multiple purchases which is capable of providing a refund to a user when the vending machine does not appropriately dispense the purchased items.

Another objective of the present invention is to provide a vending machine system for multiple purchases which is capable of accelerating the dispensing of a large quantity of purchased items.

It is also an objective of the present invention to provide an improved method for multiple purchases in a vending machine.

Accordingly, these objectives can be achieved by following the teachings of the present invention. The present invention relates to a system for multiple purchases in a vending machine, comprising a display configured to receive a user's order of multiple items, and a payment device configured to accept the user's payment, in which the ordered items are dropped by at least one dispensing coil after the user's payment is successfully accepted. Further, an elevator is configured to consecutively receive each dropped item and deliver all the dropped items to an item retrieval port in one attempt, and a drop sensor is configured to determine whether each of the ordered items is dropped to the elevator, in which a certain amount is refunded to the user in the event that at least one of the ordered items is not dropped to the elevator.

The present invention also relates to a method for multiple purchases in a vending machine, comprising the steps of receiving a user's order of multiple items through a display, accepting the user's payment through a payment device, dropping the ordered items through at least one dispensing coil after the user's payment is successfully accepted, receiving each dropped item consecutively and delivering all the dropped items to an item retrieval port in one attempt through an elevator, determining whether each of the ordered items is dropped to the elevator through a drop sensor, and refunding an certain amount corresponding to undispensed items to the user in the event that at least one of the ordered items is not dropped to the elevator.

The foregoing and other objects, features, aspects and advantages of the present invention will become better understood from a careful reading of a detailed description provided herein below with appropriate reference to the accompanying drawing.

### BRIEF DESCRIPTION OF THE ACCOMPANYING DRAWING

So that the manner in which the above recited features of the present invention can be understood in detail, a more particular description of the invention, briefly summarized above, may have been referred by embodiments, some of which are illustrated in the appended drawing. However, it is to be noted that the appended drawing illustrates only typical embodiments of this invention and are therefore not to be considered limiting of its scope. The invention may admit to other equally effective embodiments.

These and other features, benefits, and advantages of the present invention will become apparent by reference to the following text figure, with like reference numbers referring to like structures across the views, wherein:

FIG. 1 illustrates a method for multiple purchases in a vending machine in accordance with an embodiment of the present invention.

### DETAILED DESCRIPTION OF THE PREFERRED EMBODIMENTS

While the present invention is described herein by way of example using embodiments and illustrative drawing, those skilled in the art will recognize that the invention is not limited to the embodiments of drawing described, and are not intended to represent the scale of the various components. Further, some components that may form a part of the invention may not be illustrated in certain figures, for ease of illustration, and such omissions do not limit the embodiments outlined in any way. It should be understood that the drawing and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like are included in the specification solely to provide a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

The present invention relates to a system for multiple purchases in a vending machine, comprising: a display configured to receive a user's order of multiple items; and a payment device configured to accept the user's payment; wherein the ordered items are dropped by at least one dispensing coil after the user's payment is successfully accepted; characterized by an elevator configured to consecutively receive each dropped item and deliver all the dropped items to an item retrieval port in one attempt; and a drop sensor configured to determine whether each of the ordered items is dropped to the elevator; wherein an certain amount is refunded to the user in the event that at least one of the ordered items is not dropped to the elevator.

In accordance with an embodiment of the present invention, the system further comprises a multiple-purchase discount module configured to provide a discount to the user if the multiple items are purchased collectively in a single transaction. For instance, the multiple-purchase discount module can provide the discount in such a way that one item is for RM 3.00, two items are for RM 5.50, three items are for RM 8.00, and four items are for RM 10.00. Preferably, the more items the user purchases, the more discounts the user can get. The discount can be an inducement for the user to purchase more items. Said multiple-purchase discount module is pre-programmed via a processor for implementation. The processor may be connected to a center via an internet protocol so as to remotely program selected vending machine according to needs. The multiple-purchase discount module operates similarly to the purchase with purchase (PWP) promotional method. If multiple items are selected, a tier pricing can be enabled. The first selected item can be sold at the original price. If a second item is selected, the system may refer to a backend price setup table and determine a lower sale price for the second item based on the second price tier on the condition that the user buys the first item. Similarly, if more items are selected, the system may refer to the backend price setup table and determine the sale price of each item based on respective price tiers.

In accordance with an embodiment of the present invention, the system further comprises a processor integrated with a loyalty module configured to award loyalty points to the user based on the multiple items purchased. The loyalty module can be configured to assign an account to the user so as to enable the user to accumulate the loyalty points. Once a threshold amount of loyalty points associated with the account are accumulated, the user can redeem the accumulated loyalty points to obtain free gifts or discounts for next purchase. The user can first log in to the account for identity verification and each purchase shall be recorded to benefit from the loyalty rewards.

In accordance with an embodiment of the present invention, the display is configured to accept user touch input from a touchscreen monitor or remote orders from separate electronic devices such as smartphones. For example, the display can be an LCD touchscreen monitor listing items available for purchase. The user can select the desired items via the LCD touchscreen monitor. Alternatively, the user can scan a QR code available on the display via a smartphone in order to access a website or a mobile application. Subsequently, the user can select the desired items via the website or the mobile application. The display of the vending machine can communicate with the smartphone over the Internet. Internet access can be provided through mobile GSM networks by using an internet module. The internet module can be located on the processor.

In accordance with an embodiment of the present invention, the payment device supports payments made with cash, cards, online bank transfers and digital wallets. The user may make the payment through a cash acceptor or a debit/credit card reader. Alternatively, the user may make the payment through the digital wallet by scanning the QR code available on the display. The user may also make the payment through the online bank transfer after accessing the aforesaid website or mobile application.

In accordance with an embodiment of the present invention, the dispensing coil is a helical coil connected to a motor and placed on a shelf in the vending machine. Each turn of the helical coil is configured to receive and retain an item. Upon operation of the motor, the helical coil may rotate and cause the retained items to move forward. When one retained item reaches the end of the helical coil, the retained item is pushed beyond an edge of the shelf and dropped on the elevator.

In accordance with an embodiment of the present invention, the elevator is a tray or platform arranged to move vertically in the vending machine. The elevator can travel to every vertically-spaced shelf of the vending machine to safely receive each item dropped from the dispensing coil. In order to accelerate the dispensing process, the elevator is arranged to consecutively receive each dropped item and deliver all the dropped items to an item retrieval port in one attempt. For instance, the elevator can be arranged to travel to the second shelf to receive a first item, then travel to the fifth shelf to receive a second item, then travel to the eight shelf to receive a third item and eventually travel to the bottom of the vending machine to deliver all the items to the item retrieval port for the user to retrieve the three items at once.

In accordance with an embodiment of the present invention, the drop sensor can be a radiation emitting element located on one side of the elevator to emit a beam of radiation across the elevator. Further, the drop sensor comprises a reflector located on the opposite side of the elevator in order to reflect the beam of radiation. Subsequently, the drop sensor can determine whether each of the ordered items is dropped to the elevator by sensing a change in the reflected radiation. If the drop sensor can sense a slight change in the reflected radiation, an item has dropped to the elevator. A time period can be predetermined for each item dispensing. If the motor is actuated to dispense a particular item and the predetermined time period initiated by actuation of the motor runs out before the particular item is sensed by the drop sensor, the processor can send a signal to initiate the refunding.

In accordance with an embodiment of the present invention, the refunded amount is in correspondence to the total price of the at least one undispensed item. For instance, if the user purchases three items and two of the ordered items are not dispensed by the dispensing coil, an amount amounting to the total price of the two undispensed items will be refunded to the user. Preferably, the amount can be refunded to the user in accordance with the payment mode. For example, if the user makes the payment through a digital wallet, the amount will be refunded to the digital wallet of the user.

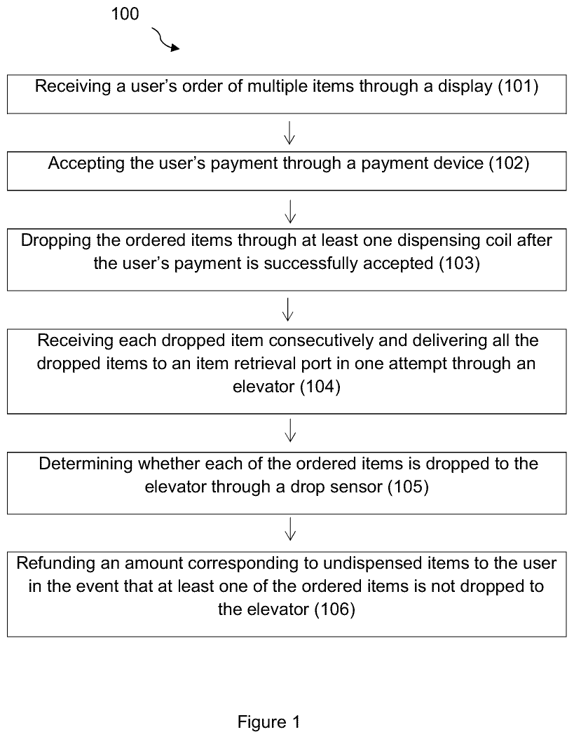

FIG. 1 illustrates a method (100) for multiple purchases in a vending machine in accordance with an embodiment of the present invention. The method (100) comprises the steps of: receiving a user's order of multiple items through a display (101); accepting the user's payment through a payment device (102); dropping the ordered items through at least one dispensing coil after the user's payment is successfully accepted (103); receiving each dropped item consecutively and delivering all the dropped items to an item retrieval port in one attempt through an elevator (104); determining whether each of the ordered items is dropped to the elevator through a drop sensor (105); and refunding an certain amount corresponding to undispensed items to the user in the event that at least one of the ordered items is not dropped to the elevator (106).

In accordance with a preferred embodiment of the present invention, the method (100) further comprises the step of providing a discount to the user through a multiple-purchase discount module if the multiple items are purchased collectively in a single transaction.

In accordance with a preferred embodiment of the present invention, the method (100) further comprises the step of awarding loyalty points to the user based on the multiple items purchased through a loyalty module.

In accordance with a preferred embodiment of the present invention, the method (100) further comprises the step of verifying identity of the user through account login prior to awarding the loyalty points to the user.

Accordingly, the above-mentioned system and method (100) overcomes the problems and shortcomings of the existing multiple-purchase vending machine systems and provides a number of advantages over them. For example, the above-mentioned system and method (100) are capable of providing a refund to the user if the vending machine fails to dispense the purchased items. Additionally, the above-mentioned system and method (100) can accelerate the dispensing process by enabling the elevator to receive and deliver all the dropped items in one go.

Various modifications to these embodiments are apparent to those skilled in the art from the description and the accompanying drawing. The principles associated with the various embodiments described herein may be applied to other embodiments. Therefore, the description is not intended to be limited to the embodiments shown along with the accompanying drawing but provides the broadest scope of consistent with the principles and the novel and inventive features disclosed or suggested herein. Accordingly, the invention is anticipated to hold on to all other such alternatives, modifications, and variations that fall within the scope of the present invention and appended claim.

1. A system for multiple purchases in a vending machine, comprising:
a display configured to receive a user's order of multiple items; and
a payment device configured to accept the user's payment;
wherein the ordered items are dropped by at least one dispensing coil after the user's payment is successfully accepted;
characterized by
an elevator configured to consecutively receive each dropped item and deliver all the dropped items to an item retrieval port in one attempt; and
a drop sensor configured to determine whether each of the ordered items is dropped to the elevator;
wherein a certain amount is refunded to the user in the event that at least one of the ordered items is not dropped to the elevator.

2. The system as claimed in claim 1, further comprising a processor integrated with a multiple-purchase discount module configured to provide a discount to the user if the multiple items are purchased collectively in a single transaction.

3. The system as claimed in claim 1, further comprising a processor integrated with a loyalty module configured to award loyalty points to the user based on the multiple items purchased.

4. The system as claimed in claim 1, wherein the display is configured to accept user touch input from a touchscreen monitor or remote orders from separate electronic devices such as smartphones.

5. The system as claimed in claim 1, wherein the payment device supports payments made with cash, cards, online bank transfers and digital wallets.

6. The system as claimed in claim 1, wherein the refunded amount is in correspondence to the total price of the at least one undispensed item.

7. A method (100) for multiple purchases in a vending machine, comprising the steps of:
receiving a user's order of multiple items through a display (101);
accepting the user's payment through a payment device (102);
dropping the ordered items through at least one dispensing coil after the user's payment is successfully accepted (103);
receiving each dropped item consecutively and delivering all the dropped items to an item retrieval port in one attempt through an elevator (104);
determining whether each of the ordered items is dropped to the elevator through a drop sensor (105); and
refunding an amount corresponding to undispensed items to the user in the event that at least one of the ordered items is not dropped to the elevator (106).

8. The method (100) as claimed in claim 7, further comprising the step of providing a discount to the user through a multiple-purchase discount module if the multiple items are purchased collectively in a single transaction.

9. The method (100) as claimed in claim 7, further comprising the step of awarding loyalty points to the user based on the multiple items purchased through a loyalty module.

10. The method (100) as claimed in claim 9, further comprising the step of verifying identity of the user through account login prior to awarding the loyalty points to the user.
